(19) United States
(12) Patent Application Publication
(10) Pub. No.: US 2023/0265787 A1
(43) Pub. Date: Aug. 24, 2023

(54) ROTARY-PISTON ENGINE

(71) Applicant: Ramzan GOYTEMIROV, Tbilisi (GE)

(72) Inventor: Ramzan GOYTEMIROV, Tbilisi (GE)

(21) Appl. No.: 18/023,759

(22) PCT Filed: Aug. 27, 2021
(86) PCT No.: PCT/GE2021/000004

§ 371 Date: Feb. 28, 2023

(30) Foreign Application Priority Data
Aug. 31, 2020 (GE) AP 2020 15427

(51) Int. Cl. F02B 55/14; F02B 55/02

(52) U.S. Cl. CPC F02B 55/14; F02B 55/02

(57) ABSTRACT

A rotary-piston engine comprises a housing (4), a cylinder (5), a combustion chamber (10), a piston (11) with a device (12) for the reciprocating movement of the piston, and a rotor (1) connected to an output shaft (9). The rotor (1) is mounted on hinges (2), and sealing partitions (3) are provided both around the edge of the perimeter and on the sides, inside the housing (4). The cylinder (5) is provided with intake, exhaust and scavenging ports (6, 7, 8). Working combustion chambers (10) are provided on the outer surface of the rotor (1) in the form of recesses. Said recesses are configured to admit the entrance of truncated heads of pistons (11). The pistons (11) are arranged in a circle around the rotor (1) and move reciprocally in the cylinders (5) in a two- or four-stroke internal combustion engine working mode by means of device (12), which is connected to the working shaft (9).

### THE FIELD OF TECHNOLOGY

The invention relates to the field of mechanical engineering, energy, namely engineering.

### PRIOR ART

From literary sources, it is known that at present the most widely in the quality of stationary power plants and power drives of vehicles used piston internal combustion engines (ICE).

Rotor piston engines (RPD) are used less often.

Piston ICE with a relatively high efficiency (utility coefficient) and good motors have a complex design. Such a complex design is explained as follows:
with a large number of alternating inertial loads and reciprocal movements with a large number of alternate inertial stresses;
a complex gas distribution mechanism with its drive;
low specific power;
restriction on increasing the number of revolutions and torque strength.

Vankel and Fred rotor engines have a high specific power with a relatively simple design. However, these engines have a number of disadvantages:
high level of temperature and toxicity of exhaust gases;
high heat and wear rate of the main parts;
high fuel consumption;
Complex in manufacture the main details.

Rotor engines do not have an advantage in terms of torque, over piston engines.

The nearest analogues of the invention declared by the author are the “internal combustion engine” /1 /1 /, the U.S. invention of the U.S. No. 3,699,930 /2 /, as well as Rotary-Piston Machines OF Intermeshing Engagement Type, I.E.

The nearest analogue of the invention claimed by the author is the RU201 1146256 patent. This invention has implemented a design that allows you to create a compact highly effective internal combustion engine with an efficiency of more than 50 % /4 /. In this invention, there are no reciprocal movements and alternating loads in the kinematic scheme. Power transfer from the working body to the main shaft occurs only due to rotational movements. These movements are carried out progressively and continuously. In one continuous rotational movement, several main structural elements of the engine are combined - rotors with working blades. These rotors are located on one working shaft. This working shaft is coordinated with rotors with a continuous rotational movement of locking drums. For one revolution of the working shaft, many auxiliary and working tacts occur at the same time. When rotating the working elements of the engine, several hermetically closed chambers of the expansion of the working body are created, which progessively and continuously increase their volume. Due to the increase in the volume, the working course of a significant length is carried out, which uses the entire power of the excessive pressure of the working gases to the end. And thereby increases the thermodynamic efficiency of the working tact, opening the exhaust window for the exhaust of the working gases. The exhaust window opens at the moment when the working gases already have a minimum residual pressure and minimum excess temperature. This way is realized by the high thermodynamic efficiency of the engine, noiselessness and purity of exhaust. It has the possibility of quantitative engine speed control (standard control of the carburetor throttle). A high coefficient of excess air is also provided (as in an engine with ignition from compression -diesel). Throughout the working cycle of the engine, a high torque develops with a constant shoulder of force, which does not depend much on the revolutions of the motor. Due to the above features, it becomes possible to build a simple but highly effective engine with preliminary mixture of formation in a standard carburetor. This is achieved without the use of complex and expensive additional devices of modern mixture of formation of such as fuel injections, high -pressure gasoline pumps and forced air drilling devices into the cylinders. Thus, high simplicity of design and a significant minimization of the kinematic diagram of the engine are achieved. And this is the key to strong reliability and possible low price with high technical and economic indicators and attractive consumer properties. The engine is compact, has a simple design and a small number of parts. This makes it possible to achieve higher working parameters, compared with the current motors of different types.

Despite all the advantages of the above analogue, he also has disadvantages. The disadvantages include the impossibility of achieving the tightness of the cameras in which the compression of the mixture occurs. This leads to significant losses of energy expended and, therefore, efficiency. In this engine, it is also impossible to achieve a high degree of compression. Therefore, according to the design of this analogue and Visiting is impossible to create a detonation environmentally friendly engine with high power and low consumption of the combustible mixture.

The purpose of the invention called “rotor-piston engine” (RLD) is to create a high-power environmentally friendly engine. The engine works reliably with a high degree of compression of the combustible mixture and with low consumption of the combustible mixture.

The uniqueness of this engine is that its parts are not destroyed, despite the high pressure in the combustion chamber. In ordinary engines, such high pressure causes destructive detonation.

### EXAMPLES

An example of the implementation of the invention (industrial applicability)

The essence of the invention is explained by a schematic drawing.

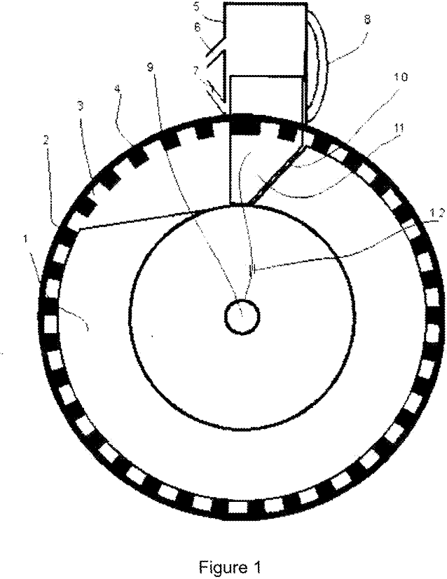

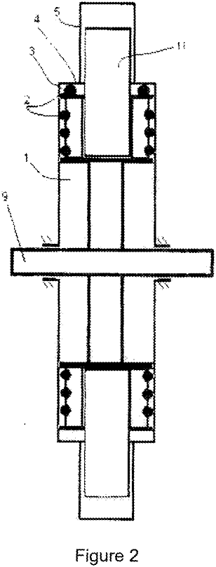

In FIGS. 1 and 2 shows the RPD scheme.

It shows a rotor (1) installed on hinges (2) with sealing partitions (3) both along the periphery of the perimeter and from the side inside the case (4); with a cylinder (5); with suction, exhaust and purge windows (6), (7) and (8);

With a weekend shaft (9).

Work chambers (10) are made on the outer surface in the form of hollows. These cavities may include pistons (11) with head truncated parts and move into them. Pistons (11) are located from the outside of the rotor around the circumference. These pistons can make reciprocating movements in cylinders (5) by means of a device (12). Device (12) connected to the working output shaft (9). This ensures absorption, compression, combustion of the combustible mixture and the release of exhaust gases. Each of the combustions of the surface of the hollow and the truncated part of the piston forming the combustion chamber are made in such a way that at the time of maximum compression of the combustible mixture they could be built in parallel relative to each other.

The detonation rotary engine works as follows:

The rotor (1) installed on hinges (2) is brought into rotational movement when it rotates the shaft (9) with external effort. Partitions (3) inside the case (4) are sealed with cameras and rotor as a whole. At the same time, the pistons (11) are associated with the output shaft () and make a reciprocating movement in the cylinders (5) by means of the device (12). First absorbed through the window (6), and then blowing through the window (8). The piston moves into the hollow and creates high pressure in the formed chamber. This pressure is created between the surfaces of the wall of the truncated piston and the wall of the hollow. After that, the mixture in the working chamber (10) is burned. The working stroke of the rotor is brought into a rotational movement with a large torque. Next, the exhaust gas exhaust occurs through the window (7). It should be paid attention to the fact that, when moving the piston down, the mixture is mixed well due to this mixture of a high speed of rotation and its high diffusion. Further, it also draws attention to the fact that the truncated part of the piston is built in parallel relative to each other at the time of maximum compression of the combustible mixture. Steepen of compression can be excessively high detonation, if compared in conventional ICE. But thanks to this design of the RPD, namely, the direction of the gas pressure force in the tangent or close to it names, detonation does not occur in ordinary ICE. And this force is directed to create a rotational torque of the shaft.

This RPD design provides a more complete combustion of the combustible mixture and eliminates the loss of energy in the VMT (67%) all this significantly increases the engine efficiency and its environmental friendliness.

1. The nearest analogues of the invention declared by the author are the design of the rotary engine for the combustion of root combustion engine compression engine.

2. U.S.A. No. 3,699,930.

3. F01C1/20 Rotary-Piston Machines or Engines of interlining england type, I. E. With Engagement of Coopering Members Similar to that of Toothed Gearing of OFERTHENAL-AXIS TYPE TOPED ROTARY PISMILAR TOOTH FORMS, 77776A2 WIPO (PCT), PCT/RU2012/001 102

4. Ru2011 146256 The next analogue of the invention declared by the author, in which the design of a six -stroke rotor engine is implemented.

1. Circular piston engine with a housing, a cylinder, a combustion chamber for the mixture, a piston with a mechanism for piston lifting movements and a rotor that is connected to the output shaft, wherein the rotor has hinges and with sealing partition walls are provided both along the periphery of the circumference and on the side inside the housing wherein at least one cylinder intake, exhaust and purging windows is provided wherein the output shaft has a working chamber wherein the working chambers on the outer surface of the rotor are formed in the form of depressions, wherein blunt heads of the pistons can be inserted into the depressions wherein the depressions are arranged in a circle around the rotor, wherein the cylinders work together with a device connected to the piston for suction, compression, burning the mixture and to emit exhaust gases, and that the surfaces of the depressions and the surfaces of the blunted piston bottom are carried out in such a way that they are arranged parallel to each other at the moment of the maximum compression of the combustible mixture.

2. Circular piston engine according to claim 1, wherein the rotor is formed as a hollow ring and the recesses are formed on its inner surface, which are adapted to immerse into the surrounding piston heads.

3. Circular piston engine according to claim 1, wherein the piston is designed in the form of a rectangular prism and the recesses are located in the middle part of the rotor on its inner or outer surface.

4. Circular piston engine according to claim 1, wherein the axis of the piston is arranged in a pointed angle to the radius of the rotor.
